(19) United States
(12) Patent Application Publication
(10) Pub. No.: US 2025/0086021 A1
(43) Pub. Date: Mar. 13, 2025

(54) APPLICATION-EMBEDDED KERNEL INSIGHTS FOR ACCELERATOR SELECTION

(71) Applicant: Telefonaktiebolaget LM Ericsson (publ), Stockholm (SE)

(72) Inventors: Martin JULIEN, Montreal (CA); Mohammad ABU LEBDEH, Montreal (CA); Dániel GÉHBERGER, Montreal (CA)

(73) Assignee: Telefonaktiebolaget LM Ericsson (publ), Stockholm (SE)

(21) Appl. No.: 18/292,879

(22) PCT Filed: Jul. 27, 2021
(86) PCT No.: PCT/IB2021/056828

§ 371 Date: Jan. 26, 2024

(51) Int. Cl. G06F 9/50

(52) U.S. Cl. CPC G06F 9/5044; G06F 2209/503; G06F 2209/509

(57) ABSTRACT

A method and system of an accelerator selection process is implemented by a computing node, where the computing node has a plurality of accelerators. The method includes receiving a request for an embedded insights-based accelerator selection for an application, determining whether the application includes embedded insights as part of the executable package of the application, and selecting at least one of the plurality of accelerators based on the embedded insights to execute the application.

### TECHNICAL FIELD

The embodiments relate to the field of resource usage in edge or cloud computing environments; and more specifically, to the system and process for utilizing insights embedded in applications to influence selection of accelerators for use in executing the kernels of respective applications.

### BACKGROUND ART

High performance computing (HPC) refers to the field of computing where computing devices are designed for high level performance relative to the general purpose computers available at the time. Computing devices that have been designed for HPC are sometimes referred to as ‘supercomputers.’ HPC computing devices have computing power measured often in floating point operations per second (FLOPS), where modern supercomputers can perform a hundred quadrillion FLOPS. Different architectures of processors have been used over time in HPC computing devices. The processors in these HPC computing device have generally been uniform or general in their operation. However, use of processors of varying types and capabilities for HPC has increased. Specialized processors are referred to as accelerators or hardware accelerators.

Cloud computing is the on-demand availability of compute and storage resources in large data centers that house a large number of computer nodes connected by internal networks Cloud computing makes these resources available without direct active management by users of the cloud computing services. The cloud computing services are often made available to users remotely via the Internet. Large clouds have functions and compute resources distributed over multiple locations. If the compute resources or functions are positioned proximate to the user and away from a centralized portion of the cloud system such resources and functions can be referred to as edge cloud services. Like HPC systems the hardware utilized by cloud systems can be varied amongst the computer nodes in the cloud system such that different types of processing capabilities are available in the form of general purpose processors and hardware accelerators.

Hardware acceleration involves the use of specialized computer hardware to perform some functions more efficiently relative to the same functions being performed on general-purpose hardware. An example of hardware acceleration is the use of a graphics processing unit (GPU) to perform graphics functions rather than using a central processing unit (CPU). Accelerators can include hardware processing components that have efficiencies for some applications or functions relative to general purpose hardware processing components, e.g., CPUs.

Accelerators can include application specific integrated circuits (ASICs) and similar hardware components. An ASIC is designed or configured to compute a specific set of operations more efficiently than a general-purpose processor that is executing the set of operations in software. Other types of accelerators can include GPUs, functions implemented on field programmable gate arrays (FPGAs), and similar specialized hardware components or combinations thereof. Accelerators, such as GPUs and FPGAs, are becoming increasingly popular as a part of high-performance computing and cloud systems.

Accelerators of different vendors have significant differences in hardware architecture, middleware support, and programming models. However, modern programming and execution frameworks for accelerators allow hardware accelerated applications to use different types and variants of accelerators for executing their specialized implementations. These frameworks enable the deployment and execution of the same accelerated function source code across different accelerator devices such as GPUs and FPGAs.

Hardware accelerated applications are applications with computation tasks that can be offloaded to accelerators. They consist of two main components (1) the code that runs on the general purpose processing components (e.g., CPUs) of a computing device, referred to as a compute node, and one or more functions that can be offloaded to accelerator devices. These accelerated functions can comprise highly parallel computing tasks and are referred to herein as kernels. The kernels that work well on one accelerator will not necessarily perform well on another as the kernels and the associated applications place distinct demands on accelerators, and accelerators from different vendors and of different types vary in their characteristics and performance.

### SUMMARY

In one embodiment, a method of an accelerator selection process is implemented by a computing node, the computing node having a plurality of accelerators, where the method includes receiving a request for an embedded insights-based accelerator selection for an application, determining whether the application includes embedded insights as part of the executable package of the application, and selecting at least one of the plurality of accelerators based on the embedded insights to execute the application.

In one embodiment, a machine-readable medium includes computer program code which when executed by a computer carries out the method of receiving a request for an embedded insights-based accelerator selection for an application, determining whether the application includes embedded insights as part of the executable package of the application, and selecting at least one of the plurality of accelerators based on the embedded insights to execute the application.

In another embodiment, a computing node includes a non-transitory machine-readable storage medium having stored therein an application with the embedded insights and an accelerator selection process, and a set of processors including general purpose processors and accelerators to execute the application, and the accelerator selection process. The accelerator selection process can involve receiving a request for an embedded insights-based accelerator selection for an application, determining whether the application includes embedded insights as part of the executable package of the application, and selecting at least one of the plurality of accelerators based on the embedded insights to execute the application.

In one embodiment, a machine-readable storage medium stores computer program code which when executed by a computer carries out functions of an application in an executable package. The executable package includes an executable file including computer program code representing serial logic to be executed by a general purpose processor and data-parallel logic to be executed by an accelerator, and a set of embedded insights wherein the embedded insights include any one or more of building insights, profiling insights, and preferences insights.

### BRIEF DESCRIPTION OF THE DRAWINGS

The embodiments may best be understood by referring to the following description and accompanying drawings that are used to illustrate embodiments. In the drawings:

FIG. 1 is a diagram of one example embodiment of an accelerated application.

FIG. 2 is a diagram of one embodiment of the embedding of kernel insights in various file types associated with applications.

FIG. 3 is a diagram of one embodiment of the mechanisms for accessing the embedded insights in the executable package of an accelerated application.

FIG. 4 is a diagram illustrating protection schemes for the embedded insights.

FIG. 5 is a diagram of a process for collecting and embedding different types of insights into an executable package at different stages of application development and deployment.

FIG. 6 is a diagram of one embodiment of a process for accelerator selection.

FIG. 7 is a diagram of one embodiment of a process of gathering insights where an AI model is present.

FIG. 8 is a diagram of one example where a trained AI model is used to provide profiling insights based on inference.

FIG. 9 is a diagram of one embodiment of an accelerator selection process of an accelerator selection mechanism.

FIG. 10 is a diagram of one embodiment of a process for generating an estimated insights compliance score for each available accelerator in a cloud computing system.

FIG. 11 is a diagram of one embodiment of a process for an insights-based AI model training process for accelerated applications.

FIG. 12 is a diagram of one embodiment of a mobile communication network including resources that form an edge cloud system.

FIG. 13 is a diagram of one embodiment of a cloud system that includes edge cloud resources and centralized cloud resources.

FIG. 14A illustrates connectivity between network devices (NDs) within an exemplary network, as well as three exemplary implementations of the NDs, according to some embodiments.

FIG. 14B illustrates an exemplary way to implement a special-purpose network device according to some embodiments.

FIG. 14C illustrates various exemplary ways in which virtual network elements (VNEs) may be coupled according to some embodiments.

FIG. 14D illustrates a network with a single network element (NE) on each of the NDs, and within this straightforward approach contrasts a traditional distributed approach (commonly used by traditional routers) with a centralized approach for maintaining reachability and forwarding information (also called network control), according to some embodiments.

FIG. 14E illustrates the simple case of where each of the NDs implements a single NE, but a centralized control plane has abstracted multiple of the NEs in different NDs into (to represent) a single NE in one of the virtual networks(s), according to some embodiments.

FIG. 14F illustrates a case where multiple VNEs are implemented on different NDs and are coupled to each other, and where a centralized control plane has abstracted these multiple VNEs such that they appear as a single VNE within one of the virtual networks, according to some embodiments.

FIG. 15 illustrates a general-purpose control plane device with centralized control plane (CCP) software 1550), according to some embodiments.

### DETAILED DESCRIPTION

The following description describes methods and apparatus for the use of application embedded insights to implement methods of compute resource allocation for the applications in high performance computing, central cloud, edge cloud, and/or similar execution environments. The application embedded insights are utilized by an accelerator selection process to identify the best available compute resources to execute kernels in each application. The accelerator selection process can enable a cloud system and similar computing environments to efficiently manage available resources, in particular the allocation of application functions to accelerators in the cloud system.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the embodiments. It will be appreciated, however, by one skilled in the art that the embodiments may be practiced without such specific details. In other instances, control structures, gate level circuits and full software instruction sequences have not been shown in detail in order not to obscure the embodiments. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments. However, such notation should not be taken to mean that these are the only options or optional operations, and/or that blocks with solid borders are not optional in certain embodiments.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The operations in the flow diagrams will be described with reference to the exemplary embodiments of the other figures. However, it should be understood that the operations of the flow diagrams can be performed by embodiments other than those discussed with reference to the other figures, and the embodiments discussed with reference to these other figures can perform operations different than those discussed with reference to the flow diagrams.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals-such as carrier waves, infrared signals). Thus, an electronic device (e.g., a computer) includes hardware and software, such as a set of one or more processors (e.g., wherein a processor is a microprocessor, controller, microcontroller, central processing unit, graphics processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Parallel computing involves the execution of different functions or components of an application in parallel using different compute resources in cloud computing environments (i.e., on cloud systems) or HPC system. Parallel computing is enabled by the availability of multi-core central processing units (CPUs) and accelerators (e.g., graphics processing units (GPU) and field programmable gate arrays (FPGA)). Accelerators as used herein are special-purpose processing devices designed to speed up parallel and compute-intensive aspects of the applications. Accelerators are becoming increasingly popular means to assist the general-purpose processors (i.e., CPUs) in running applications by offloading complex and intensive computational functions (or tasks) to run on these accelerators. The applications that have computation functions or tasks that can be offloaded to accelerators are referred to herein as hardware accelerated applications. The hardware accelerated applications, referred to herein interchangeably as accelerated applications and hardware accelerated applications, consist of two main components: (1) the code that runs on the host computer (i.e., on the compute node), and (2) one or more functions that can be offloaded to accelerators. These functions that can be offloaded to accelerators often include highly parallel computing tasks and are referred to herein as kernels.

Different hardware accelerated applications place distinct demands on accelerators, and the applications that work well on one accelerator will not necessarily perform well on another accelerator, and this is also true for the different kernels associated with the applications. The reason is that the accelerators are designed by different vendors, and have significant differences in hardware architecture, middleware support, and programming models, which results in different processing characteristics and performance for different types of functions or tasks.

Programming and execution frameworks for accelerators, such as Open Computing Language (OpenCL) by Khronos Group, and the OneAPI open source project, allow accelerated applications to use different types and variants of accelerators for executing their specialized kernel implementations. For example, such frameworks allow the same acceleration function source code to be used for deployment across different accelerator devices, such as GPUs and FPGAS.

The examples and embodiments described herein relate primarily to the use of embedded insights for hardware accelerated applications for use in cloud systems to improve the selection of accelerators for the execution of the kernels of these applications. However, those skilled in the art would understand that the principles, processes, and structures described herein with relation to cloud computing based implementation are also applicable to other computing environments where heterogenous compute resources are available such as in HPC scenarios and similar use cases. For sake of clarity and conciseness the examples herein related to cloud systems but are not limited to such applications.

One challenging problem for executing hardware accelerated applications is how to appropriately select one of the available compute resources on a compute node to run a given kernel in an application so that the full capability of the compute node is exploited. The problem becomes more challenging when the application needs to be deployed on infrastructure with heterogeneous resources, such as an edge cloud computing infrastructure in a cloud system. Edge cloud resources are inherently highly heterogeneous (e.g., different models of CPU, GPU, and FPGAs from various vendors can be available at different edge cloud sites) and resource-constrained compared to central cloud resources. That means a hardware accelerated application in a computing environment that relies on edge cloud resources can be deployed on large variety of compute node types over time, thus there will be a need to find the best offloading configuration (where to run every kernel) for an application for different compute node types and configurations.

When deploying accelerated applications on central cloud systems, the application providers can be requested or required to provide information specifically on the type of accelerator to allocate to the application for hardware acceleration purposes. Thus, when developing accelerated applications for central cloud systems, application developers can design and implement kernels to be executed on specific types of accelerators, and the kernels can be optimized for specific models or versions of those hardware accelerators. This typically leads to cloud orchestration systems having to request information from application providers specifically about each accelerated application's requirements in terms of hardware accelerators. While this way of deploying applications requires application providers to provide more information, it also limits the autonomy of systems to select the most suitable hardware accelerators that are available autonomously.

Because development frameworks for accelerators allow accelerated applications to be developed with kernels destined to run across several different types of accelerators, it is not possible for an orchestrator of a cloud system at the edge cloud or central cloud to determine autonomously the most appropriate accelerator type, or variant, to use at deployment time. To make such a decision, either information from application providers would be required, or real application deployments would have to be done across several accelerators, for which performance measurements would be performed for evaluation purposes. In practice, there is not a mechanism for this information to be provided by the application providers at deployment time or that takes performance measurements at deployment time. Such performance measurements introduce significant delay and overhead to the process of compute resource allotment and would be a manual process. Further, different hardware accelerated applications implement different kernels of different complexity. Currently, there is no standard way of defining the complexity of a kernel implementation, which makes it relatively impossible for an orchestrator of a cloud system to autonomously decide on the most appropriate accelerator to allocate to a hardware accelerated application for providing best performance. As there is no standard way of expressing the complexity of kernel implementations, it is difficult to design or to train artificial intelligence (AI) models to infer an application or kernel performance over certain accelerators. Typically, the training of an AI model would require the inputs from multiple different kernels, described in terms of similar complexity indicators and measured performance.

The embodiments provide a system that overcomes these challenges and obstacles. At development time, ‘insights’ on an accelerated application's kernels can be provided by the application building and profiling processes. The ‘insights’ as used herein refers to data embedded in an application that provides information about the characteristics of the associated kernel that can inform an orchestrator of a cloud system as to the optimal accelerator that can be utilized from a set of available accelerators at run time. A ‘set,’ as used herein, refers to any positive whole number of items including one item. The insights can be embedded directly within the generated accelerated application standalone executable. Insights can relate to any type of information that can help describe an application's kernel., Insight information that can identify the kernel uniquely, describe the logical complexity of the kernel's implementation (e.g., number of instructions, number of loops, and similar characteristics that affect complexity), and similar information. In some embodiments, the insights can also include information that is provided to developers as optional artifacts during compilation, but which is not otherwise available when executing the kernels. The embedded insights can be accessible using runtime application programming interfaces (APIs), and/or using specialized utility applications. The insights-based accelerator selection can improve predictions of the performance of accelerated applications on different accelerators, contributing to the allocation of the most appropriate accelerator, at deployment time, to each accelerated application by the cloud orchestration system.

In the embodiments, the accelerator selection process can calculate the insights compliance of a given hardware accelerated application for each available accelerator. The accelerator with the highest insights compliance score can be selected for the application or a specific kernel of the application. The calculation of the insights compliance would be based on a comparison between the embedded insights of an accelerated application (provided by the application), and the capacity/capabilities/performance of each accelerator (provided by the cloud system and/or compute node). The accelerator selection algorithm can be configured to consider weights for reflecting the relative importance of the different insights, as well as to consider the application preferences insights. When an insights-trained AI model is available, then an additional set of insights referred to as “profiling insights” can be inferred by the AI model and used in the calculation of the insights compliance of an accelerator, instead of relying solely on the embedded insights.

In one embodiment, the embedded insights could also be used for training AI models, for example for enhancing an AI model used by the accelerator selection process. In this embodiment, the embedded insights could be used as input features to the AI model, while real measured performance data would be used to infer predicted characteristics for further enhancing the accelerator selection process.

The embodiments provide advantages over the existing art. The embodiments can utilize kernel-related insights to provide support for improved accelerator selection for accelerated applications at application deployment time. The insights can be organized into different categories of insights. The embodiments can provide a standardized way of specifying and reporting insights for accelerated applications. The embodiments provide a set of kernel insights embedded within accelerated application executables, independent of any externally provided set of information.

In some embodiments, the embedded insights can be certified by the application developers. As kernel insights are embedded within application executables, the insights can be generated from privileged accesses to applications' source code during the development environment phase, which is not available at deployment time. Kernel insights are embedded directly within accelerated applications, which makes the insights always available within the application executable without requiring any external resources.

The embodiments allow for more autonomous accelerated application deployments, as application providers would not be required to provide as much detailed information about their specific performance requirements and support for different accelerators. The embodiments enable performance prediction of accelerated applications across different accelerators. The embodiments enable more efficient accelerator allocation by cloud orchestration systems, which can lead to a more efficient resource utilization of cloud infrastructure. The embodiments enable AI models to be trained with the provided embedded kernel insights (as features) from several different accelerated applications.

In the embodiments, accelerated applications have insights for their hardware accelerated kernels directly embedded within their own standalone executables. The embedded insights would primarily be intended to provide valuable information to other applications and services on the identity and the complexity of the kernels, as well as on the characteristics and the key performance expectations for the kernels.

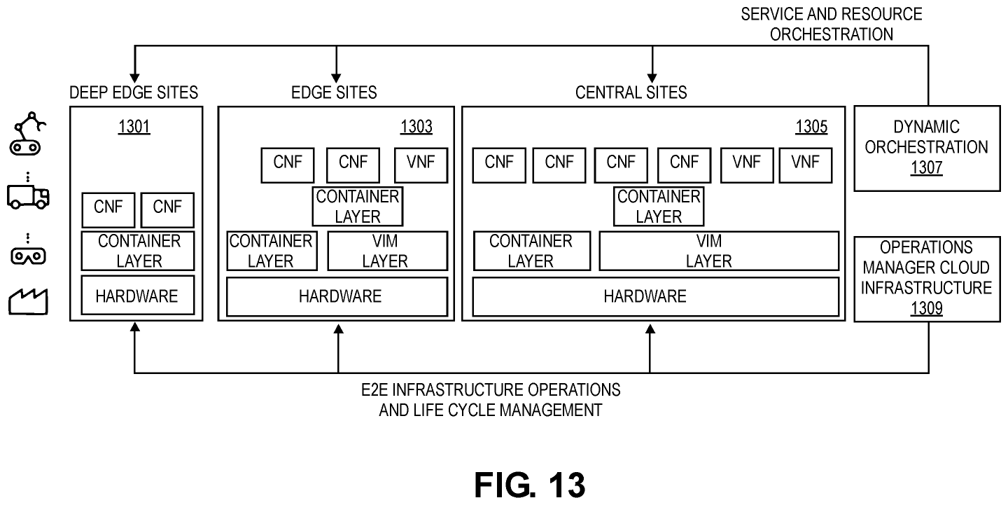

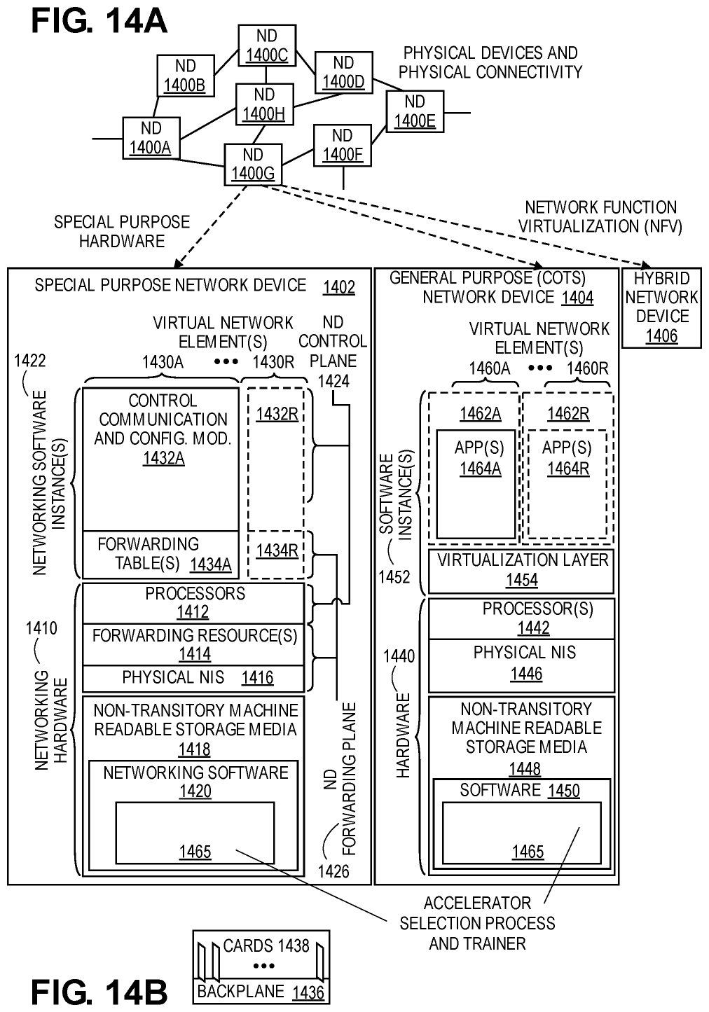

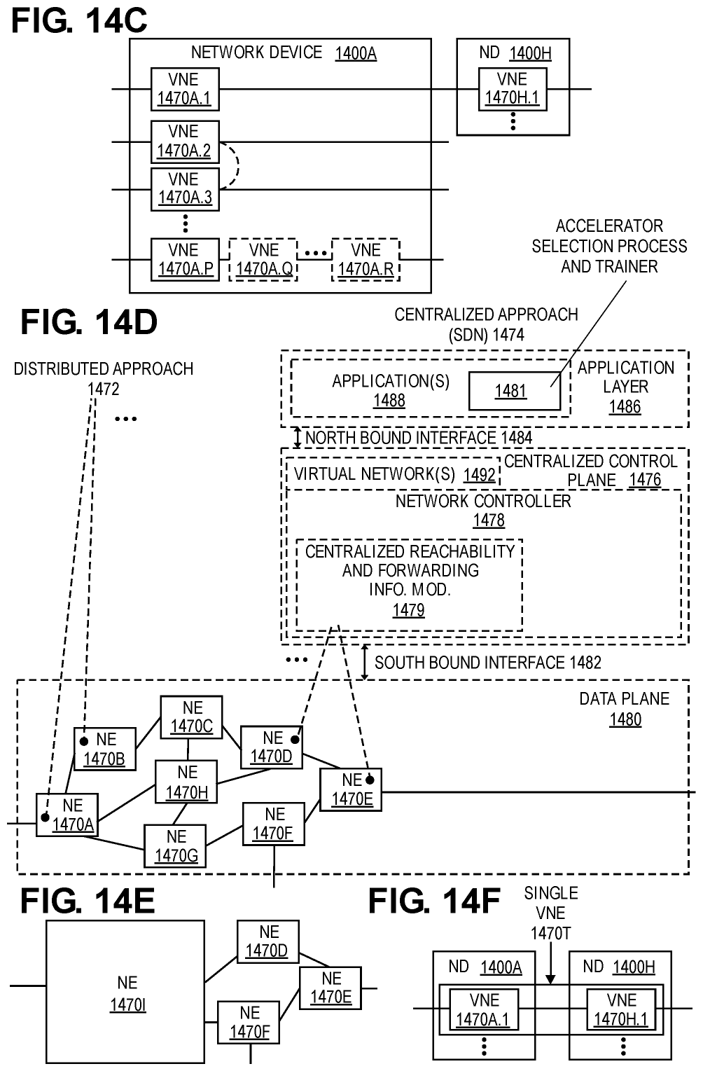

Embedded insights can improve the selection of the most appropriate hardware accelerator for an accelerated application. By selecting hardware accelerators based on application-embedded insights, the cloud orchestration systems can be more aware of the characteristics of each accelerated application's kernels, leading to a more autonomous selection and efficient use of the accelerator resources of a cloud system infrastructure. The embodiments of the embedded insights, accelerator selection process, and AI model training can be utilized as part of a service that manages the resources of the cloud system. The embedded insights, accelerator selection process, and AI model training, can in some embodiments be deployed in a mobile communication composed of a set of network devices as described in relation to FIGS. 13 and 14.

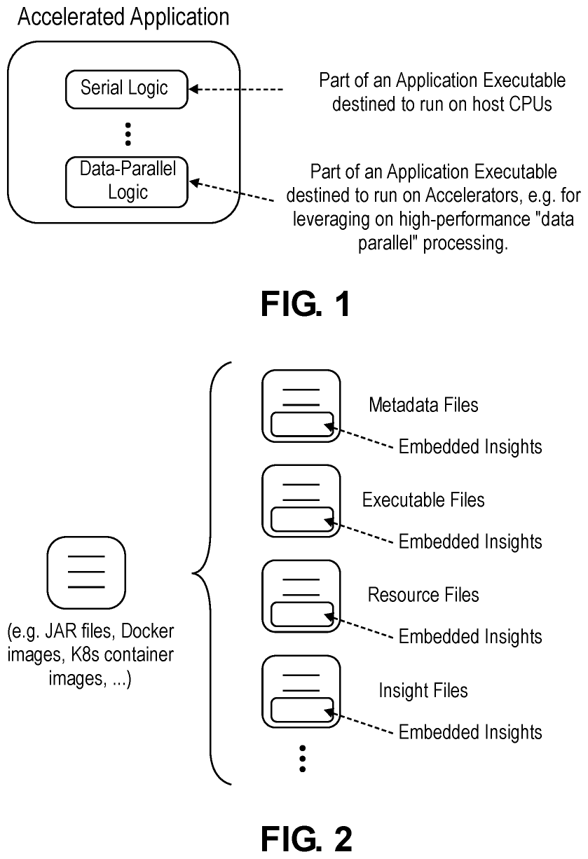

FIG. 1 is a diagram of one example embodiment of an accelerated application. The example accelerated application includes serial logic and data-parallel logic, where the serial logic can be most efficiently executed on general purpose processors and the data-parallel logic can be most efficiently executed on certain hardware accelerators. In the embodiments, the accelerated application is designed such that the compute-intensive tasks or functions, such as those tasks or functions requiring massive data-parallel processing capacity, can be offloaded to specialized hardware accelerators, such as GPUs, FPGAs, AI processing units, and similar accelerators.

General purpose processors (e.g., CPUs) can be utilized to execute the serial portion of application logic, whereas accelerators are more suited to execute the data-parallel portion (i.e., the kernel) of their processing logic. Accelerated applications have their generic processing (e.g., the serial logic) tasks executed on general purpose processors (e.g., CPUs). The more specialized and compute-intensive tasks are executed on hardware accelerators for faster and more efficient execution since the accelerators can offer better data-parallel processing.

Different accelerated applications can implement different kernels that have varied levels of complexity, parallelism, resource usage patterns, and similar characteristics and can be developed for specific types of accelerators. The embodiments provide kernel insights, related to an application's capacity to offload its data-parallel processing tasks to hardware accelerators, that can improve the selection process for accelerated applications with respect to the selection and allocation of hardware accelerators onto cloud infrastructures. The kernel insights can contribute to enhancing both application performance and overall cloud system efficiency.

In the embodiments, accelerated applications have kernel insights for their hardware accelerated kernels directly embedded within the standalone executable of the accelerated application. By embedding kernel insights directly within accelerated applications, each accelerated application carries significant information relative to their own kernel(s). Such information, i.e., insights, can be used by cloud orchestrators to simplify the management, and optimize the efficiency, of cloud systems. For example, cloud orchestrators can use embedded kernel insights to provide a more autonomous mechanism for the selection and the allocation of hardware accelerator resources to accelerated applications.

Embedding kernel insights within accelerated application executables can provide advantages including providing a set of kernel insights within accelerated applications executables, which (1) are independent of any externally provided set of information, (2) have certification from the application developers, (3) are generated from privileged accesses to applications' source code during the development environment phase, and (4) can be standardized on a specification of kernel insights, from the definition of insights to their secured access.

Depending on development and execution environments, different solutions (i.e., different formats, organization, contents) for embedding insights within an accelerated application can be used. In the embodiments, embedding insights within an accelerated application provides the capacity to keep kernel insights within an accelerated application deliverable for execution on a cloud system infrastructure.

In cloud orchestration systems, such as OpenStack and Kubernetes, support is provided to embed information directly within standalone executable packages. The cloud orchestration systems have embedded information in the execution packages to specify an execution context required for running the application, e.g., by embedding the deployment information within the standalone application executable package.

FIG. 2 is a diagram of one embodiment of the embedding of kernel insights in various file types associated with applications. Kernel insights can be embedded within accelerated application executable packages, by adding the provided insights to one of the files included in the package. Any one or more of the files in the executable packages can include insights. In some embodiments, a dedicated file is utilized for storing insights (e.g., the “insights file” in FIG. 2). In other embodiments, other files might also be designated for insights storage, e.g., the metadata or the resource files. In the illustrated example, the executable package is any one of a Java ARchive (JAR) file, Docker image, containers, container runtime interface (CRI)-based containers, or similar executable package. Any one of these executable packages can include any one or more of a metadata file, executable file, resource files, insights file, or similar files that can be part of the respective executable package file. Any one or more of the files in the executable package can include embedded insights.

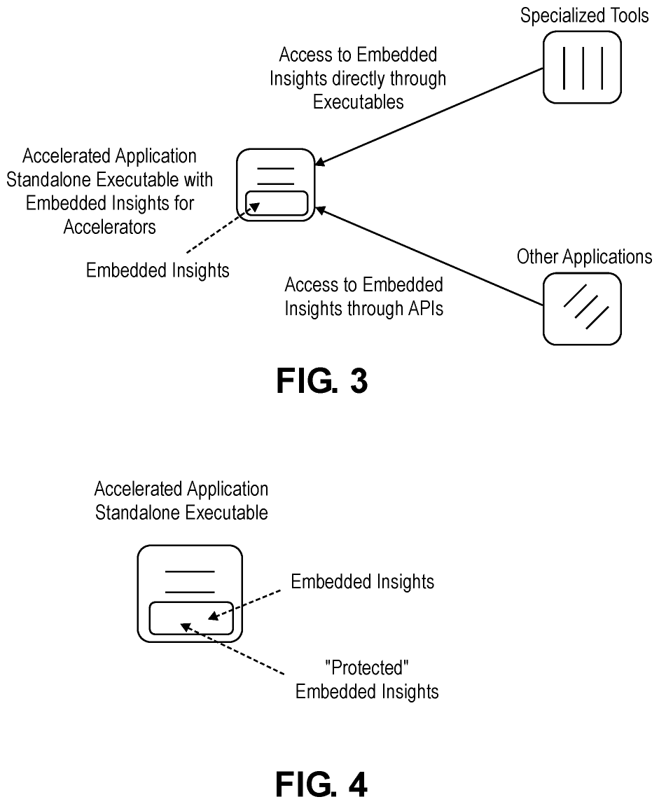

FIG. 3 is a diagram of one embodiment of the mechanisms for accessing the embedded insights in the executable package of an accelerated application. The embodiment includes several mechanisms for accessing the embedded insights of an accelerated application. As shown in FIG. 3, the embedded insights can be accessed through specialized tools, APIs, or similar mechanisms. A runtime interface (or API) can define functions supported by the cloud execution environment that make the embedded insights available to other applications. Specialized tools, i.e., special cloud execution environment programs with proper permissions can fetch the embedded insight information directly from an accelerated application executable.

Because the embedded insights would be located within accelerated application executables, the cloud execution environment would provide and enforce appropriate security mechanisms for granting access to such information. The access to the embedded insights would have strict access limitations to accelerator selection functions and similar functions that would need access to the embedded insights.

FIG. 4 is a diagram illustrating protection schemes for the embedded insights. As shown in FIG. 4, in some embodiments secure access to insights can be defined by some accelerated application developers or providers, by certain management systems or by certain execution environments. The level of security required to access an embedded insight can be tied to the set of embedded insights as a whole, on a per insight basis, tied to groups or sub-sets of the insights or similar permissions arrangements. In some embodiments, the level or type of access that is granted to embedded insights can also be dependent on the different interfaces used for accessing the insights. For example, different levels of access can be granted via a specialized tool relative to an API access.

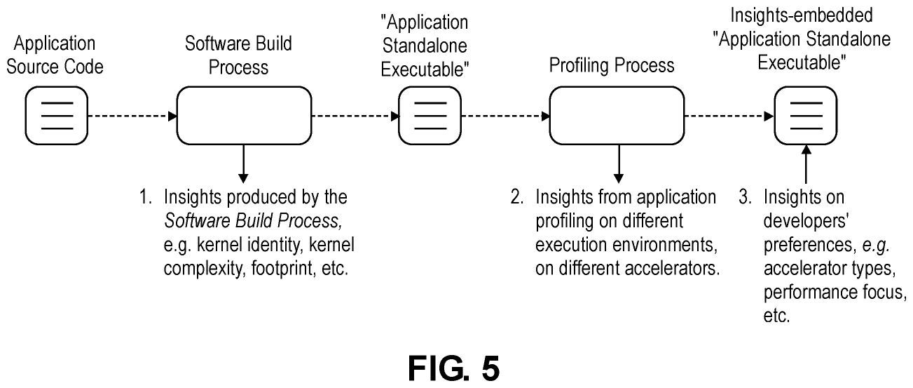

FIG. 5 is a diagram of a process for collecting and embedding different types of insights into an executable package at different stages of application development and deployment. The embedded kernel insights provide information on the identity and the complexity of an accelerated application's kernels, as well as on their related characteristics and key performance expectations. Some insights can have greater weight in accelerator selection than other insights. The weighting of the insights however can be specified and changed. Insights can also be used in different combinations to provide a better understanding of the overall needs of an accelerated application for accelerators.

As shown in FIG. 5, kernel insights can come from multiple different sources during the development stages of an accelerated application. A first source of kernel-related insights can originate during the application building process. Insights generated from analysis of the software code can provide valuable insights on an accelerated application's kernels. Software compilers can provide significant detail about the complexity of hardware accelerated kernels and identify parallelism in the code as the compiler processes the application code to directly generate byte executable code from high-level programming languages. The compiler can directly generate insights to identify functions that can benefit from specific accelerators or types of accelerators. Other applications that process the source code and that participate in making the executable during a software build process can also identify and record insights. The insights that are generated can include kernel identity (e.g., a type or descriptor), kernel complexity (e.g., a rating or classification of complexity), resource usage or size (i.e., a footprint), and similar information.

In some embodiment, the application profiling process could also further contribute to adding and/or enhancing kernel insights by executing the accelerated applications for kernel characteristics measurement and performance evaluation purposes using simulated and/or real hardware accelerators. The profiling process can record metrics or scores of the simulated or actual execution of the application and/or the kernels as insights. To complement the insights provided through the application building and profiling processes, more subjective insights can also be included as provided directly by the application developers themselves. The developer insights can include a preferred accelerator type or hierarchy of preferred accelerators, performance focus or types, or similar information.

Thus, the insights can be organized or categorized into three sets of insights based on their origins, (1) application building insights, (2) application profiling insights, and (3) application preferences. The application building insights can be collected while compiling accelerated applications. The development environment toolchains are capable of determining the level of complexity of an application's hardware-accelerated kernels and include such insights directly within the application executable itself. For example, insights can be collected directly from compiler artifacts.

Application profiling insights are collected once an accelerated application is built. In some embodiments, application profiling insights can be added by application developers who can embed additional insights relative to the measured performance of kernels across different accelerators. For example, insights could be directly coming from specialized profiling tools, and/or data analytics collected during the verification process. In other embodiments, the collection of profiling insights can be automated and part of a simulation or testing of the application after it is built.

Application preferences insights can be collected from application developers and similar sources that provide subjective insights. While insights collected through application building and profiling can be more objective and/or technical, this category of insights enables application developers to provide high-level recommendations and preferences, which correspond to a more subjective assessment of the kernels. These preferences insights can be recorded and added to the executable package by the application developers, users, administrators, and similar entities at any point prior to application deployment or runtime.

During the application building process, the following information might be embedded into accelerated application executables as insights, (1) application kernel identity, (2) development/execution framework, (3) workload complexity indicators, and similar information. The application kernel identity identifies an application kernel uniquely, both to allow recognizing each one easily and differentiating each kernel from other kernels, as well as to enable comparisons between the kernels. The application kernel identity can include a clear description of each kernel.

The development/execution framework can include information on the development framework and its associated compilation process, e.g., the OneAPI. The development/execution framework can be recorded as insights to enable the orchestrator to understand the technology used to obtain a kernel implementation. The technology used for generating a kernel bytecode, e.g., the transient or accelerator-specific binary format of the kernel executable, could be used to describe the technology required for executing an application's kernel, as well as to identify the type of acceleration functions that might be provided. Information on whether a kernel is in an OpenCL or SPIR-V format can be used to make an appropriate selection of an accelerator.

Workload complexity indicators can be stored as insights or used to derive the information to be stored in the insights. Complexity indicators provide information about a kernel that can be used to determine its level of complexity, e.g., in terms of data processing and data management, as well as resource dimensioning and distribution. In some embodiments, the workload complexity indicators can be used for comparing different kernels together. For example, the complexity indicators of existing kernels can be compared or referenced to predict the performance characteristics of newly introduced kernels.

Complexity indicators can include or be derived from a number of iterations per parallel loop. This insight can be used to estimate the processing complexity involved by knowing the number of times a parallel loop would need to be executed. Complexity indicators can also include a number and type of instructions per iteration. The number of instructions per iteration can be an indicator of the relative complexity of a kernel implementation. Different low-level accelerator instructions can imply different latency, performance, or a different amount of resources are needed for execution. The number of instructions per iteration can distinguish between the different types of instructions required by a kernel implementation. For example, instructions could be categorized as memory access instructions, arithmetic operations, branch instructions, number and alignment type of array memory accesses, and similar instruction types. The number of memory accesses can be considered a significant indicator of kernel complexity, assuming that each memory access could require sparse accelerator resources and imply additional processing latency.

In data-parallel programming-based applications, each instruction is executed on an array of memory locations. Depending on kernel implementations, it might be possible that an implementation cannot assure a perfect alignment of array memory accesses, which might require an additional latency for accessing the required data. It is considered that the alignment type of memory accesses could represent a significant indicator of kernel complexity. For example, the following types of array memory accesses can be identified a coalesced access (aligned access), an offset access (misaligned access), a stride access (misaligned access with stride, i.e., beyond the size of an array), an indirect access (i.e. using a computed address), a data transfer size, and similar types of memory accesses. A data transfer size corresponds to the amount of data that is transferred between an accelerated application and its allocated accelerator.

During the application profiling process, the following information can be embedded as insights into accelerated application executables (1) accelerator characteristics, (2) dynamic usage patterns, and similar information. Accelerator characteristics describes the kernel relative to accelerators. Kernels can perform differently on different accelerators, potentially resulting in different functional and/or performance characteristics. This category of insights can help in determining or estimating the characteristics of a kernel across different accelerators. The characteristics can be provided per accelerator variant or per acceleration type, as deemed necessary for the associated kernel. The functional characteristics relate to the description of specialized functional aspects of a kernel on an accelerator, e.g., reporting the usage of special acceleration engines or instruction sets. The performance characteristics can be measured and/or estimated performance indicators for the kernel execution on the associated accelerator. A number of performance indicators can be included in the insights, e.g., execution time, jitter, power utilization, resource usage, memory bandwidth, and similar metrics.

Dynamic Usage Patterns are insights that describe how some kernels are used differently by applications. The differences can depend on the application logic, traffic volume, traffic patterns, on the expected precision or quality of the corresponding accelerated functions, and similar usage patterns. For example, processing a high-definition image might require more resources and execution time than for a low-definition image. Similarly, processing an image every second would make use of accelerator resources more often than processing an image every minute.

Application Preference insights that are embedded into accelerated application executables can include (1) key performance objectives (2) accelerator affinity, and similar subjective insights. Key performance objectives can include application developers specifying certain characteristics to aim for, or to consider when deciding on the most appropriate accelerator to use for an accelerated application. For example, certain kernels can be more sensitive to latency than others, while some others might be considering more important to consider bandwidth as their highest priority. Thus, application developers can specify preference insights that favor low latency or low bandwidth usage for the respective kernels.

Accelerator affinity insights can enable application developers to recommend certain accelerator types, accelerator models and/or accelerator features/capabilities for executing kernels. For example, recommendations provide information to enable the accelerator selection process to weight different accelerators for the process to decide on the most appropriate accelerator to use for an accelerated application.

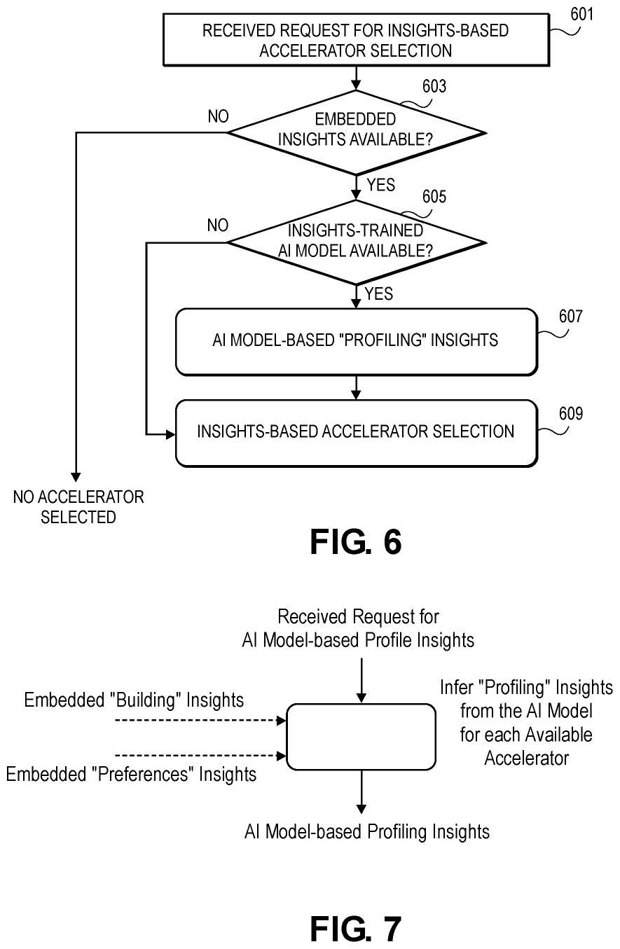

FIG. 6 is a diagram of one embodiment of a process for accelerator selection. The accelerator selection process utilizes the kernel insights embedded in the accelerated application. By leveraging the kernel insights embedded directly within the accelerated application, the cloud orchestration systems can execute an accelerator selection process that is enhanced to select and allocate the most suitable hardware accelerator available for each kernel in each accelerated application.

The insights-based accelerator selection mechanism can function solely on the provided application-embedded insights, without requiring any external interaction with other services, and/or independently provisioned databases of information, which minimizes latency and overhead in the selection process. In some embodiments, to further enhance the accelerator selection process accuracy and efficacy, AI models can be trained and used for selecting the most appropriate hardware accelerator. For AI model training purposes, embedded kernel insights can be used as features input to the training process, especially if the embedded insights would be standardized for all accelerated applications. In the embodiments, cloud systems provisioning can be simplified, while cloud systems management could be made more autonomous, by using the insight-based accelerator selection process, because less information is required during accelerated application deployments onto cloud infrastructures.

As an example, when an accelerated application is deployed on a cloud infrastructure, cloud application deployment systems typically require a lot of additional deployment-related information for efficiently deploying an accelerated application. Such required information includes information on the supported accelerators and the performance requirements, as well as the intended usage profile of accelerators. In the embodiments, such information is provided by the embedded insights of each accelerated application, which allows the selection of hardware accelerators to be simplified during application deployments. Without the embedded insights this information would have to be determined by more involved collection of external data or manual intervention. Also, the accelerator selection is made more autonomous with a smarter decision process based on meaningful insights for each accelerated application's kernels.

Due to the relative complexity of cloud application deployment systems, the embodiments support and improve an accelerator selection mechanism by providing and utilizing the embedded insights. The embodiments thereby enhance the whole deployment process. As shown in FIG. 6, the process evaluates accelerated applications with embedded insights to select accelerators for their execution. For the insights-based accelerator selection mechanism, at least two approaches can be employed where selection of accelerators is (1) based only on an accelerated application's embedded insights, (2) based on the embedded building and preferences insights, as well as on trained AI model-based profiling insights, or similar arrangements and reliance on embedded insights. When embedded insights are not available, then the accelerator selection process can inform the requester that no accelerator could be selected for the accelerated application, rely on manual or non-embedded insight bases selection processes, apply a default option, or utilize a similar process. The insights-based accelerator selection mechanism can be used by a cloud deployment orchestration service to identify or suggest an accelerator to utilize for a kernel, but it can be left to the cloud deployment orchestration service to select an accelerator on its own, as the insights-based accelerator selection mechanism can be considered as only one mechanism used by the cloud deployment orchestration service among others to select an accelerator or the resources to be allotted to an application.

In FIG. 6, the example accelerator selection process is triggered by a cloud deployment orchestration system that calls the accelerator selection mechanism to obtain a selection of an accelerator for a given kernel of an application (Block 601). The accelerator selection mechanism can receive an identifier or link to the accelerated application executable package. The accelerator selection mechanism can access the execution package of the application using an API, specialized tools, or similar mechanisms. A check is made whether any embedded insights are present in the executable package (Block 603). In some embodiments, if no embedded insights are present, then the accelerator selection process does not select an accelerator and that process is left to the cloud deployment orchestration system. If embedded insights are available, then a check can be made to determine whether any insights trained AI model is available (Block 605). The embedded insights can identify the AI trained model, which can be separately stored in the cloud system and accessible to the accelerator selection mechanism. If an AI model is not available, then the accelerator selection can proceed based on the embedded insights in the executable package including application building insights, application profiling insights that are not AI model derived, and application preferences insights. Where the AI model is available, then the process can apply the insights from the executable package to the AI model as feature inputs and receive AI model derived profiling insights (Block 607). The AI model derived profiling insights can be combined with the other insights to make an insights-based accelerator selection from the available accelerators in the cloud.

When a trained AI model is available for an executable package, then the profiling insights can be inferred by the AI model. In some embodiments, when available, the profiling insights inferred by the AI model can completely override the profiling embedded insights provided by an accelerated application. In other embodiments, the profiling insights from the AI model inference are combined with those that are embedded.

FIG. 7 is a diagram of one embodiment of a process of gathering insights where an AI model is present. As shown in FIG. 7, the AI model can be used to get profiling insights for each available accelerator, provided that the accelerated application can provide its own embedded insights related to building insights and preferences insights. The AI model can be trained with real observed and measured data obtained from the deployment of multiple different accelerated applications across the available accelerators. As shown in FIG. 7, the AI model execution is triggered by a request for AI model derived profiling insights. This request can initiate an assessment for each kernel in an application, and each available accelerator or type of accelerator. The AI model receives as input the embedded building insights, and preferences insights and can use them as inputs to the AI model, which can then be used to the infer the AI model based profiling insights.

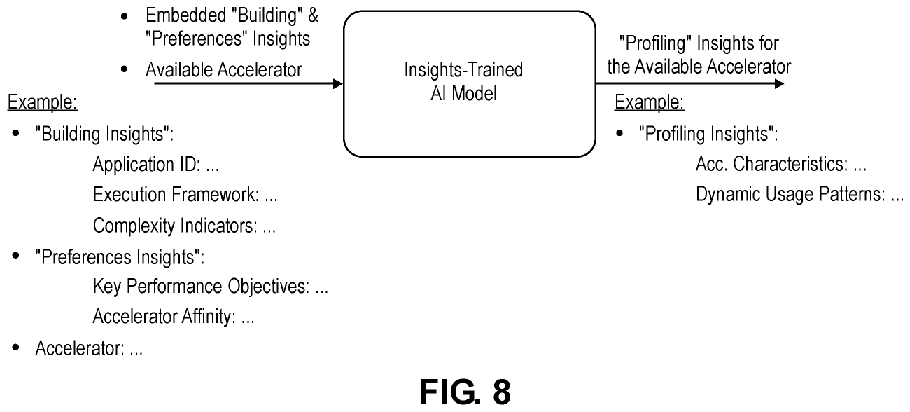

FIG. 8 is a diagram of one example where a trained AI model is used to provide profiling insights based on inference. The AI model performs inference on the predicted performance of the kernels of an accelerated application. In the example, embedded insights of the accelerated application are provided as inputs to the AI model, along with a given available accelerator, which can be used to infer “profiling” insights for the accelerated application on the given accelerator. The trained AI model can be trained on performance (simulated or real) of any number of accelerated application kernels on any number of accelerators along with the associated insights for the accelerated applications.

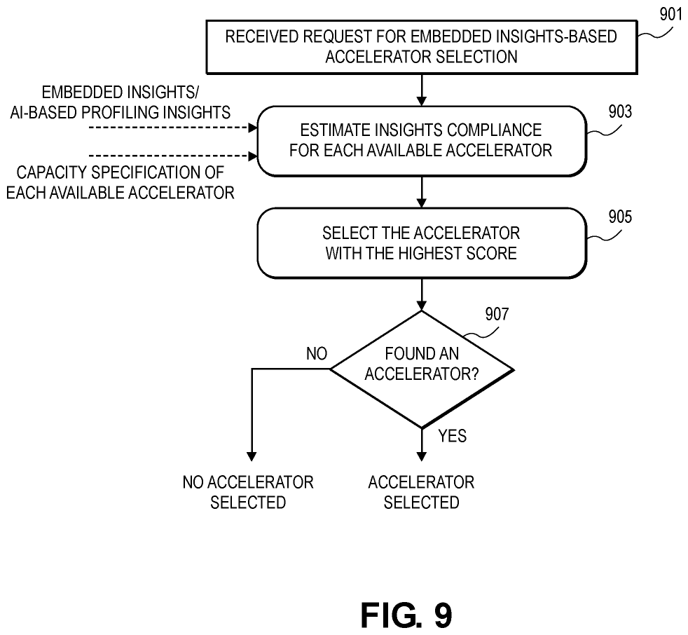

FIG. 9 is a diagram of one embodiment of an accelerator selection process of an accelerator selection mechanism. Each accelerated application provides kernel insights embedded within their own standalone application executable. The accelerator selection process can select an accelerator based on the provided insights enabling an autonomous selection of accelerators. As shown in FIG. 9, the selection process can be triggered by the accelerator selection mechanism receiving a request for accelerator selection (Block 901). The accelerator selection process performs a calculation of an insights compliance estimation for each available accelerator (Block 903). Then the accelerator selection process allows for a final selection of the most appropriate accelerator, i.e., the one providing the highest insights compliance score (Block 905). If an accelerator with a score is found, then the selection is returned (Block 907). If no accelerator with a score is found, then a ‘no accelerator’ or similar response can be returned.

As inputs to the insights compliance algorithm (Block 902), the application's kernel insights would be provided, as well as information on all the accelerators available to the accelerator selection process. If profiling insights have been obtained through the insights-trained AI model, then those insights can used instead of or in combination with the profiling insights already embedded within the application itself. The information provided on each available accelerator can be shared with the selection process in a format that can be aligned and compatible with the application's embedded insights. For example, the insights parameters and the presentation format specifications enable a comparison of an application's kernel building insights with equivalent building insights provided for the available accelerators. Such a comparison can, for example, take the form of comparing the supported execution frameworks of an application's kernel with the supported execution frameworks of an available accelerator. In some embodiments, the accelerator selection process can compare the kernel complexity indicators of an application's kernel, with the capacity of an available accelerator to support such complexity indicators to identify whether these insights are co-extensive.

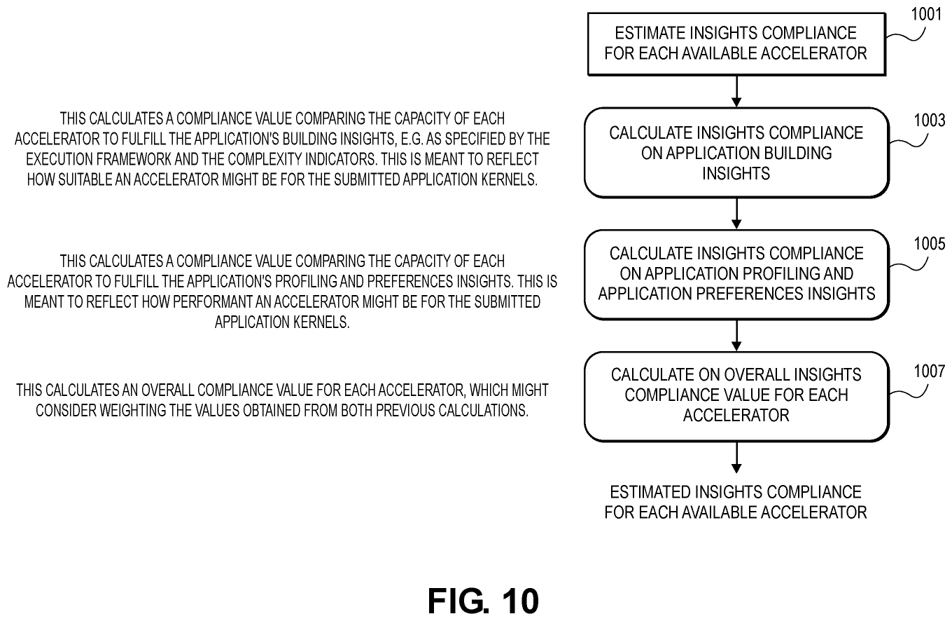

FIG. 10 is a diagram of one embodiment of a process for generating an estimated insights compliance score for each available accelerator in a cloud computing system. The calculation of the insights compliance score can be an assessment of how suitable an accelerator is for an application kernel when comparing the provided embedded insights from an accelerated application with the information provided on the cloud system's available accelerators.

As shown in FIG. 10, a calculation of the insights compliance can be triggered as part of an accelerator selection process request (Block 1001). The insights compliance score computation can first perform a comparison of insights categorized as building insights (Block 1003), followed by a second calculation performed by comparing insights categorized as profiling and preferences (Block 1005), and then followed by a calculation combining the results from the two previous calculations, for each accelerator (Block 1007).

By first considering available accelerators based on application building insights, the accelerator selection process can evaluate accelerators that seem best suited to execute the application's kernels, as determined by the supported runtime execution frameworks and kernel complexity indicators (Block 1003). Then, by considering the available accelerators based on application profiling and preferences insights, the selection process can evaluate accelerators based on the measured characteristics and the intended usage patterns of applications' kernels over different accelerators (Block 1005). In some embodiments, the developers' preferences can be included as part of the algorithm calculating the insights compliance.

The insights compliance algorithm can utilize weighting for the different insights being compared, as some insights might be considered more important than others. For example, if an application's preferences insights would indicate that latency would be more important than bandwidth, then the weight used for the latency would be higher than the weight used to evaluate the bandwidth of an accelerator. The weighting of insights can be defined as part of the respective embedded insights.

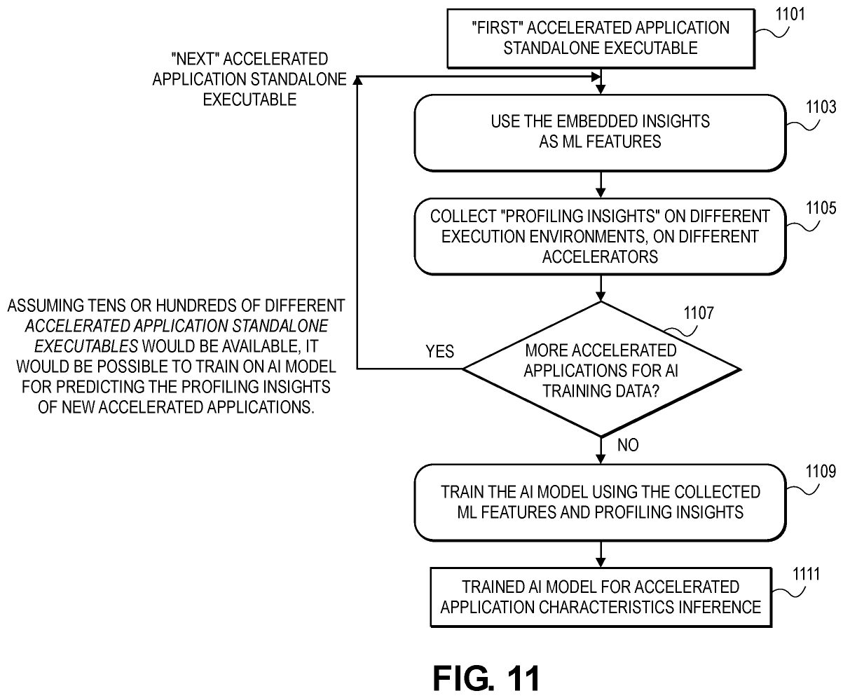

FIG. 11 is a diagram of one embodiment of a process for an insights-based AI model training process for accelerated applications. In some embodiments, the accelerated applications provide a relatively standard set of insights on their implemented kernels. The provided standard set of insights can be used as main input features for the training of an AI model to help with the selection of an accelerator for accelerated applications. For example, by leveraging the embedded insights relative to the accelerated application workload complexity, an AI model can be trained using those complexity indicators as AI features, while using the measured characteristics as outputs for inference purposes, either for classification or for regression.

As shown in FIG. 11, as accelerated applications are deployed on cloud infrastructures, the training data can be collected on each one for the purpose of training the AI model. The process can begin with selecting an accelerated application to process (Block 1101). The training data can leverage the provided insights in the executable packages of the accelerated applications, as well as real performance data measured over real cloud infrastructures, where accelerated applications have been deployed and performing their intended operations (Block 1103). The profiling insights for different execution environments and different accelerators can be collected (Block 1105). The training data from several accelerated applications can be used to efficiently train the AI model (Block 1107). The data from as many accelerated applications as possible can be used for training the AI model to improve the accuracy of the AI model. Thus, the process can iterate and select a next accelerated application to utilize as input (Block 1101). Even where several applications' kernels could be considered relatively similar, with similar expected performance and characteristics over the different accelerators, the added collected data from each can improve the AI model by inclusion for the training data. Once a minimal set of training data have been collected or all of the available accelerated applications have been processed, the AI model training can be performed (Block 1109). At this stage, any type of AI training techniques and principles can be used, which would also evaluate the level of confidence of the prediction for the trained AI model.

The training of an AI model could be performed once and be used efficiently afterwards (Block 1111). In other embodiments, the training of an AI model for accelerator selection could be retrained regularly, for example depending on the newly deployed accelerated applications, the diversity of the new kernels being developed, and the latest availability of new accelerator technologies.

The embodiments provide many benefits and advancements in the art. At development time, insights on an accelerated application's kernels can be provided through both the application building phase and the application profiling phase, as well as through application preferences provided by application developers. During the application building phase, kernel insights can consist of information related to application kernel identity, development/execution frameworks, and workload complexity indicators. During the application profiling phase, kernel insights can consist of information related to accelerators characteristics and dynamic usage patterns. Insights on application preferences, can consist of information related to key performance objectives and accelerator affinity. The provided insights can be embedded directly within the generated accelerated application standalone executable. The embedded insights can be accessible using runtime APIs, or using specialized utility applications. Secure access to the embedded insights is supported.

The embedded insights of an accelerated application can be used to select the most appropriate accelerator for executing the implemented kernels. For accelerator selection, the accelerator selection process can calculate the insights compliance of a given accelerated application for each available accelerator. The accelerator with the highest insights compliance score can be selected for the application. The calculation of the insights compliance can be based on a comparison between the embedded insights of an accelerated application (provided by the application), and the capacity/capabilities of each accelerator (provided by the cloud system). The accelerator selection algorithm uses weights for reflecting the relative importance of the different insights, as well as to consider the application preferences insights. When an insights-trained AI model is available, then the profiling insights inferred by the AI model is used in the calculation of the insights compliance of an accelerator, instead of the profiling embedded insights. The embedded insights can also be used for training AI models, for example for enhancing the AI model used by the accelerator selection process. In that scenario, the embedded insights can be used as input features to the AI model, while real measured performance data would be used to infer profiling insights for further enhancing the accelerator selection mechanism.

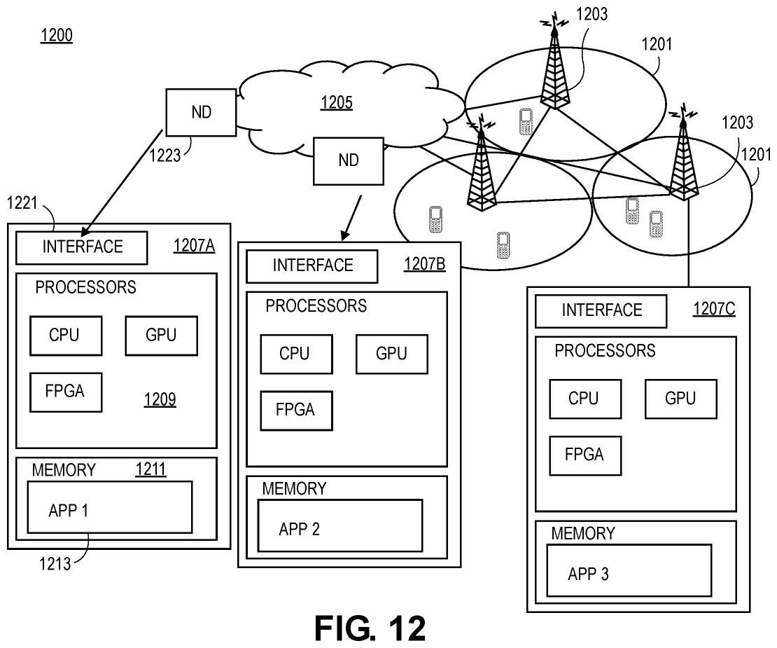

FIG. 12 is a diagram of one embodiment of a mobile communication network including resources that form an edge cloud system. The mobile communication network 1200 can include a core network 1205 that includes a set of network devices (ND) 1223, and a set of radio access networks (RANs) 1201. The RANs 1201 consist of a set of base stations 1203 that provide connectivity to a set of user equipment (UEs) such as mobile devices (i.e., cellular phones). A base station 1203 can service and provide connectivity to any number of UEs. The base station 1203 can enable communication between UEs and other UEs or the core network 1205. Each base station 1203 can provide a set of compute resources 1307C. The compute resources can include a communication interface, processors including hardware accelerators (e.g., CPUs, GPUs, FPGAs and similar accelerators) and similar components. The base station 1203 can also include storage including dynamic memory, static memory, long term storage media, and similar components. The base station memory can be a set of memory devices that form a larger memory and/or storage system. In some embodiments, the memory can be divided amongst the available processors with certain accelerators utilizing dedicated memory components and/or storage. The accelerated applications can be stored in and/or operate in these memory devices after deployment and during run time. Similarly, the components of the accelerator selection process can be stored in this memory.

The core network 1205 can also include computing nodes such as network devices 1223 that provide a set of computing resources 1207A-B that can form part of a centralized cloud system or an edge cloud system. These computing resources 1207A-B can similarly include communication interfaces 1215, processors 1209, memory 1211, and similar components. The interface 1215 can be any type of networking interface for wired or wireless communication. Any number or variety of processors including CPUs, GPUs, FPGAs, and similar processing devices and accelerators can be included in the processors 1209. The computing resources 1207A-B can also include memory/storage 1211 including dynamic memory, static memory, long term storage media, and similar components. The base station memory can be a set of memory devices that form a larger memory and/or storage system. In some embodiments, the memory 1211 can be divided amongst the available processors with certain accelerators utilizing dedicated memory components and/or storage. The accelerated applications 1213 can be stored in and/or operate in these memory devices after deployment and during run time. Similarly, the components of the accelerator selection process can be stored in this memory.

FIG. 13 is a diagram of one embodiment of a cloud system that includes edge cloud resources and centralized cloud resources. In this embodiment, the AI training and accelerator selection process is implemented in a distributed cloud system than includes edge cloud sites 1301, 1303 (e.g., a deep edge site 1301 and standard edge site 1303), central cloud site 1305 and management components 1307, 1309. Deep edge sites 1301 are further removed and have fewer resources than an edge site 1303.

The deep edge sites 1301 are positioned closest to UEs and include a hardware layer with any number of general-purpose processors and accelerators. A container layer such as Docker, Kubernetes, or similar system can execute over the hardware layer to support application execute where the support any number of applications or functions running in containers. The applications and functions can be executed as cloud-native network functions (CNFs), virtualized network functions (VNFs), or similar containerized functions.

The edge sites 1303 are positioned close to UEs and include a hardware layer with any number of general-purpose processors and accelerators. A container layer such as Docker, Kubernetes, or similar system can execute over the hardware layer to support application execute where the support any number of applications or functions running in containers. A virtualized infrastructure manager (VIM) is present to support VNFs. In some embodiments, a container layer can run over the VIM layer. The applications and functions can be executed as CNFs, VNFs, or similar containerized functions.

The centralized sites 1305 are positioned close to the core of a mobile communication network and include a hardware layer with any number of general-purpose processors and accelerators. A container layer such as Docker, Kubernetes, or similar system can execute over the hardware layer to support application execute where the support any number of applications or functions running in containers. A virtualized infrastructure manager (VIM) is present to support VNFs. In some embodiments, a container layer can run over the VIM layer. The applications and functions can be executed as CNFs, VNFs, or similar containerized functions.

The dynamic orchestration component 1307 can manage the deployment and handling of the CNF, VNF, and similar containerized functions. The operation manager cloud infrastructure 1309 can manage the hardware, container layer, VIM, and related aspects of the cloud system.

FIG. 14A illustrates connectivity between network devices (NDs) within an exemplary network, as well as three exemplary implementations of the NDs, according to some embodiments. FIG. 14A shows NDs 1400A-H, and their connectivity by way of lines between 1400A-1400B, 1400B-1400C, 1400C-1400D, 1400D-1400E, 1400E-1400F, 1400F-1400G, and 1400A-1400G, as well as between 1400H and each of 1400A, 1400C, 1400D, and 1400G. These NDs are physical devices, and the connectivity between these NDs can be wireless or wired (often referred to as a link). An additional line extending from NDs 1400A, 1400E, and 1400F illustrates that these NDs act as ingress and egress points for the network (and thus, these NDs are sometimes referred to as edge NDs; while the other NDs may be called core NDs).

Two of the exemplary ND implementations in FIG. 14A are: 1) a special-purpose network device 1402 that uses custom application-specific integrated-circuits (ASICs) and a special-purpose operating system (OS); and 2) a general purpose network device 1404 that uses common off-the-shelf (COTS) processors and a standard OS.

The special-purpose network device 1402 includes networking hardware 1410 comprising a set of one or more processor(s) 1412, forwarding resource(s) 1414 (which typically include one or more ASICs and/or network processors), and physical network interfaces (NIs) 1416 (through which network connections are made, such as those shown by the connectivity between NDs 1400A-H), as well as non-transitory machine readable storage media 1418 having stored therein networking software 1420. During operation, the networking software 1420 may be executed by the networking hardware 1410 to instantiate a set of one or more networking software instance(s) 1422. Each of the networking software instance(s) 1422, and that part of the networking hardware 1410 that executes that network software instance (be it hardware dedicated to that networking software instance and/or time slices of hardware temporally shared by that networking software instance with others of the networking software instance(s) 1422), form a separate virtual network element 1430A-R. Each of the virtual network element(s) (VNEs) 1430A-R includes a control communication and configuration module 1432A-R (sometimes referred to as a local control module or control communication module) and forwarding table(s) 1434A-R, such that a given virtual network element (e.g., 1430A) includes the control communication and configuration module (e.g., 1432A), a set of one or more forwarding table(s) (e.g., 1434A), and that portion of the networking hardware 1410 that executes the virtual network element (e.g., 1430A).

The networking software 1420 can include the accelerator selection process, AI trainer, and related components 1465, which function as described herein.

The special-purpose network device 1402 is often physically and/or logically considered to include: 1) a ND control plane 1424 (sometimes referred to as a control plane) comprising the processor(s) 1412 that execute the control communication and configuration module(s) 1432A-R; and 2) a ND forwarding plane 1426 (sometimes referred to as a forwarding plane, a data plane, or a media plane) comprising the forwarding resource(s) 1414 that utilize the forwarding table(s) 1434A-R and the physical NIs 1416. By way of example, where the ND is a router (or is implementing routing functionality), the ND control plane 1424 (the processor(s) 1412 executing the control communication and configuration module(s) 1432A-R) is typically responsible for participating in controlling how data (e.g., packets) is to be routed (e.g., the next hop for the data and the outgoing physical NI for that data) and storing that routing information in the forwarding table(s) 1434A-R, and the ND forwarding plane 1426 is responsible for receiving that data on the physical NIs 1416 and forwarding that data out the appropriate ones of the physical NIs 1416 based on the forwarding table(s) 1434A-R.

FIG. 14B illustrates an exemplary way to implement the special-purpose network device 1402 according to some embodiments. FIG. 14B shows a special-purpose network device including cards 1438 (typically hot pluggable). While in some embodiments the cards 1438 are of two types (one or more that operate as the ND forwarding plane 1426 (sometimes called line cards), and one or more that operate to implement the ND control plane 1424 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 1436 (e.g., a first full mesh coupling the line cards and a second full mesh coupling all of the cards).

Returning to FIG. 14A, the general purpose network device 1404 includes hardware 1440 comprising a set of one or more processor(s) 1442 (which are often COTS processors) and physical NIs 1446, as well as non-transitory machine readable storage media 1448 having stored therein software 1450. During operation, the processor(s) 1442 execute the software 1450 to instantiate one or more sets of one or more applications 1464A-R. While one embodiment does not implement virtualization, alternative embodiments may use different forms of virtualization. For example, in one such alternative embodiment the virtualization layer 1454 represents the kernel of an operating system (or a shim executing on a base operating system) that allows for the creation of multiple instances 1462A-R called software containers that may each be used to execute one (or more) of the sets of applications 1464A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 1454 represents a hypervisor (sometimes referred to as a virtual machine monitor (VMM)) or a hypervisor executing on top of a host operating system, and each of the sets of applications 1464A-R is run on top of a guest operating system within an instance 1462A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 1440, directly on a hypervisor (in which case the unikernel is sometimes described as running within a LibOS virtual machine), or in a software container, embodiments can be implemented fully with unikernels running directly on a hypervisor represented by virtualization layer 1454, unikernels running within software containers represented by instances 1462A-R, or as a combination of unikernels and the above-described techniques (e.g., unikernels and virtual machines both run directly on a hypervisor, unikernels and sets of applications that are run in different software containers).

The software 1450 can include the accelerator selection process, AI trainer, and related components 1465, which function as described herein.

The instantiation of the one or more sets of one or more applications 1464A-R, as well as virtualization if implemented, are collectively referred to as software instance(s) 1452. Each set of applications 1464A-R, corresponding virtualization construct (e.g., instance 1462A-R) if implemented, and that part of the hardware 1440 that executes them (be it hardware dedicated to that execution and/or time slices of hardware temporally shared), forms a separate virtual network element(s) 1460A-R.

The virtual network element(s) 1460A-R perform similar functionality to the virtual network element(s) 1430A-R—e.g., similar to the control communication and configuration module(s) 1432A and forwarding table(s) 1434A (this virtualization of the hardware 1440 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments are illustrated with each instance 1462A-R corresponding to one VNE 1460A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 1462A-R to VNEs also apply to embodiments where such a finer level of granularity and/or unikernels are used.

In certain embodiments, the virtualization layer 1454 includes a virtual switch that provides similar forwarding services as a physical Ethernet switch. Specifically, this virtual switch forwards traffic between instances 1462A-R and the physical NI(s) 1446, as well as optionally between the instances 1462A-R; in addition, this virtual switch may enforce network isolation between the VNEs 1460A-R that by policy are not permitted to communicate with each other (e.g., by honoring virtual local area networks (VLANs)).

The third exemplary ND implementation in FIG. 14A is a hybrid network device 1406, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 1402) could provide for para-virtualization to the networking hardware present in the hybrid network device 1406.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 1430A-R, VNEs 1460A-R, and those in the hybrid network device 1406) receives data on the physical NIs (e.g., 1416, 1446) and forwards that data out the appropriate ones of the physical NIs (e.g., 1416, 1446). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 14C illustrates various exemplary ways in which VNEs may be coupled according to some embodiments. FIG. 14C shows VNEs 1470A.1-1470A.P (and optionally VNEs 1470A.Q-1470A.R) implemented in ND 1400A and VNE 1470H.1 in ND 1400H. In FIG. 14C, VNEs 1470A.1-P are separate from each other in the sense that they can receive packets from outside ND 1400A and forward packets outside of ND 1400A; VNE 1470A.1 is coupled with VNE 1470H.1, and thus they communicate packets between their respective NDs; VNE 1470A.2-1470A.3 may optionally forward packets between themselves without forwarding them outside of the ND 1400A; and VNE 1470A.P may optionally be the first in a chain of VNEs that includes VNE 1470A.Q followed by VNE 1470A.R (this is sometimes referred to as dynamic service chaining, where each of the VNEs in the series of VNEs provides a different service—e.g., one or more layer 4-7 network services). While FIG. 14C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 14A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 14A may also host one or more such servers (e.g., in the case of the general purpose network device 1404, one or more of the software instances 1462A-R may operate as servers; the same would be true for the hybrid network device 1406; in the case of the special-purpose network device 1402, one or more such servers could also be run on a virtualization layer executed by the processor(s) 1412); in which case the servers are said to be co-located with the VNEs of that ND.

A virtual network is a logical abstraction of a physical network (such as that in FIG. 14A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network-originated attacks, to avoid malformed route announcements), and management capabilities (e.g., full detection and processing).

FIG. 14D illustrates a network with a single network element on each of the NDs of FIG. 14A, and within this straight forward approach contrasts a traditional distributed approach (commonly used by traditional routers) with a centralized approach for maintaining reachability and forwarding information (also called network control), according to some embodiments. Specifically, FIG. 14D illustrates network elements (NEs) 1470A-H with the same connectivity as the NDs 1400A-H of FIG. 14A.

FIG. 14D illustrates that the distributed approach 1472 distributes responsibility for generating the reachability and forwarding information across the NEs 1470A-H; in other words, the process of neighbor discovery and topology discovery is distributed. For example, where the special-purpose network device 1402 is used, the control communication and configuration module(s) 1432A-R of the ND control plane 1424 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 1470A-H (e.g., the processor(s) 1412 executing the control communication and configuration module(s) 1432A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 1424. The ND control plane 1424 programs the ND forwarding plane 1426 with information (e.g., adjacency and route information) based on the routing structure(s). For example, the ND control plane 1424 programs the adjacency and route information into one or more forwarding table(s) 1434A-R (e.g., Forwarding Information Base (FIB), Label Forwarding Information Base (LFIB), and one or more adjacency structures) on the ND forwarding plane 1426. For layer 2 forwarding, the ND can store one or more bridging tables that are used to forward data based on the layer 2 information in that data. While the above example uses the special-purpose network device 1402, the same distributed approach 1472 can be implemented on the general purpose network device 1404 and the hybrid network device 1406.

FIG. 14D illustrates that a centralized approach 1474 (also known as software defined networking (SDN)) that decouples the system that makes decisions about where traffic is sent from the underlying systems that forwards traffic to the selected destination. The illustrated centralized approach 1474 has the responsibility for the generation of reachability and forwarding information in a centralized control plane 1476 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 1476 has a south bound interface 1482 with a data plane 1480 (sometime referred to the infrastructure layer, network forwarding plane, or forwarding plane (which should not be confused with a ND forwarding plane)) that includes the NEs 1470A-H (sometimes referred to as switches, forwarding elements, data plane elements, or nodes). The centralized control plane 1476 includes a network controller 1478, which includes a centralized reachability and forwarding information module 1479 that determines the reachability within the network and distributes the forwarding information to the NEs 1470A-H of the data plane 1480 over the south bound interface 1482 (which may use the OpenFlow protocol). Thus, the network intelligence is centralized in the centralized control plane 1476 executing on electronic devices that are typically separate from the NDs.

For example, where the special-purpose network device 1402 is used in the data plane 1480, each of the control communication and configuration module(s) 1432A-R of the ND control plane 1424 typically include a control agent that provides the VNE side of the south bound interface 1482. In this case, the ND control plane 1424 (the processor(s) 1412 executing the control communication and configuration module(s) 1432A-R) performs its responsibility for participating in controlling how data (e.g., packets) is to be routed (e.g., the next hop for the data and the outgoing physical NI for that data) through the control agent communicating with the centralized control plane 1476 to receive the forwarding information (and in some cases, the reachability information) from the centralized reachability and forwarding information module 1479 (it should be understood that in some embodiments, the control communication and configuration module(s) 1432A-R, in addition to communicating with the centralized control plane 1476, may also play some role in determining reachability and/or calculating forwarding information-albeit less so than in the case of a distributed approach; such embodiments are generally considered to fall under the centralized approach 1474, but may also be considered a hybrid approach).

While the above example uses the special-purpose network device 1402, the same centralized approach 1474 can be implemented with the general purpose network device 1404 (e.g., each of the VNE 1460A-R performs its responsibility for controlling how data (e.g., packets) is to be routed (e.g., the next hop for the data and the outgoing physical NI for that data) by communicating with the centralized control plane 1476 to receive the forwarding information (and in some cases, the reachability information) from the centralized reachability and forwarding information module 1479; it should be understood that in some embodiments, the VNEs 1460A-R, in addition to communicating with the centralized control plane 1476, may also play some role in determining reachability and/or calculating forwarding information-albeit less so than in the case of a distributed approach) and the hybrid network device 1406. In fact, the use of SDN techniques can enhance the NFV techniques typically used in the general purpose network device 1404 or hybrid network device 1406 implementations as NFV is able to support SDN by providing an infrastructure upon which the SDN software can be run, and NFV and SDN both aim to make use of commodity server hardware and physical switches.

FIG. 14D also shows that the centralized control plane 1476 has a north bound interface 1484 to an application layer 1486, in which resides application(s) 1488. The centralized control plane 1476 has the ability to form virtual networks 1492 (sometimes referred to as a logical forwarding plane, network services, or overlay networks (with the NEs 1470A-H of the data plane 1480 being the underlay network)) for the application(s) 1488. Thus, the centralized control plane 1476 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

The application layer 1486 can include the accelerator selection process, AI trainer, and related components 1481 which function as described herein.

While FIG. 14D shows the distributed approach 1472 separate from the centralized approach 1474, the effort of network control may be distributed differently or the two combined in certain embodiments. For example: 1) embodiments may generally use the centralized approach (SDN) 1474, but have certain functions delegated to the NEs (e.g., the distributed approach may be used to implement one or more of fault monitoring, performance monitoring, protection switching, and primitives for neighbor and/or topology discovery); or 2) embodiments may perform neighbor discovery and topology discovery via both the centralized control plane and the distributed protocols, and the results compared to raise exceptions where they do not agree. Such embodiments are generally considered to fall under the centralized approach 1474, but may also be considered a hybrid approach.

While FIG. 14D illustrates the simple case where each of the NDs 1400A-H implements a single NE 1470A-H, it should be understood that the network control approaches described with reference to FIG. 14D also work for networks where one or more of the NDs 1400A-H implement multiple VNEs (e.g., VNEs 1430A-R, VNEs 1460A-R, those in the hybrid network device 1406). Alternatively or in addition, the network controller 1478 may also emulate the implementation of multiple VNEs in a single ND. Specifically, instead of (or in addition to) implementing multiple VNEs in a single ND, the network controller 1478 may present the implementation of a VNE/NE in a single ND as multiple VNEs in the virtual networks 1492 (all in the same one of the virtual network(s) 1492, each in different ones of the virtual network(s) 1492, or some combination). For example, the network controller 1478 may cause an ND to implement a single VNE (a NE) in the underlay network, and then logically divide up the resources of that NE within the centralized control plane 1476 to present different VNEs in the virtual network(s) 1492 (where these different VNEs in the overlay networks are sharing the resources of the single VNE/NE implementation on the ND in the underlay network).

On the other hand, FIGS. 14E and 14F respectively illustrate exemplary abstractions of NEs and VNEs that the network controller 1478 may present as part of different ones of the virtual networks 1492. FIG. 14E illustrates the simple case of where each of the NDs 1400A-H implements a single NE 1470A-H (see FIG. 14D), but the centralized control plane 1476 has abstracted multiple of the NEs in different NDs (the NEs 1470A-C and G-H) into (to represent) a single NE 14701 in one of the virtual network(s) 1492 of FIG. 14D, according to some embodiments. FIG. 14E shows that in this virtual network, the NE 1470I is coupled to NE 1470D and 1470F, which are both still coupled to NE 1470E.

FIG. 14F illustrates a case where multiple VNEs (VNE 1470A.1 and VNE 1470H.1) are implemented on different NDs (ND 1400A and ND 1400H) and are coupled to each other, and where the centralized control plane 1476 has abstracted these multiple VNEs such that they appear as a single VNE 1470T within one of the virtual networks 1492 of FIG. 14D, according to some embodiments. Thus, the abstraction of a NE or VNE can span multiple NDs.

While some embodiments implement the centralized control plane 1476 as a single entity (e.g., a single instance of software running on a single electronic device), alternative embodiments may spread the functionality across multiple entities for redundancy and/or scalability purposes (e.g., multiple instances of software running on different electronic devices).

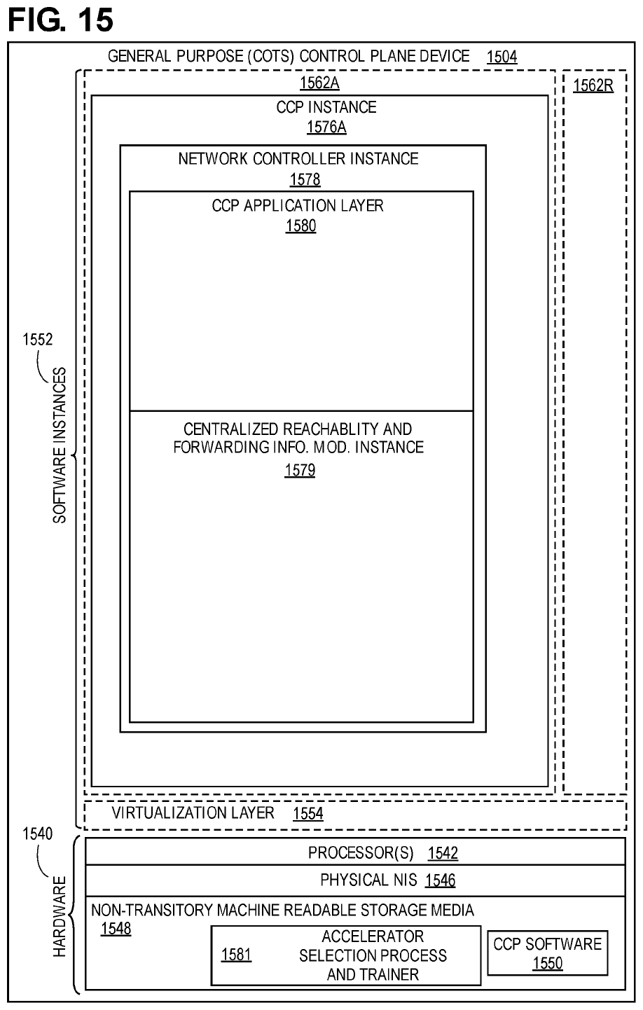

Similar to the network device implementations, the electronic device(s) running the centralized control plane 1476, and thus the network controller 1478 including the centralized reachability and forwarding information module 1479, may be implemented a variety of ways (e.g., a special purpose device, a general-purpose (e.g., COTS) device, or hybrid device). These electronic device(s) would similarly include processor(s), a set of one or more physical NIs, and a non-transitory machine-readable storage medium having stored thereon the centralized control plane software. For instance, FIG. 15 illustrates, a general purpose control plane device 1504 including hardware 1540 comprising a set of one or more processor(s) 1542 (which are often COTS processors) and physical NIs 1546, as well as non-transitory machine readable storage media 1548 having stored therein centralized control plane (CCP) software 1550.

The non-transitory machine readable storage medium 1548 can include the accelerator selection process, AI trainer, and related components 1581, which function as described herein.

In embodiments that use compute virtualization, the processor(s) 1542 typically execute software to instantiate a virtualization layer 1554 (e.g., in one embodiment the virtualization layer 1554 represents the kernel of an operating system (or a shim executing on a base operating system) that allows for the creation of multiple instances 1562A-R called software containers (representing separate user spaces and also called virtualization engines, virtual private servers, or jails) that may each be used to execute a set of one or more applications; in another embodiment the virtualization layer 1554 represents a hypervisor (sometimes referred to as a virtual machine monitor (VMM)) or a hypervisor executing on top of a host operating system, and an application is run on top of a guest operating system within an instance 1562A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 1540, directly on a hypervisor represented by virtualization layer 1554 (in which case the unikernel is sometimes described as running within a LibOS virtual machine), or in a software container represented by one of instances 1562A-R). Again, in embodiments where compute virtualization is used, during operation an instance of the CCP software 1550 (illustrated as CCP instance 1576A) is executed (e.g., within the instance 1562A) on the virtualization layer 1554. In embodiments where compute virtualization is not used, the CCP instance 1576A is executed, as a unikernel or on top of a host operating system, on the “bare metal” general purpose control plane device 1504. The instantiation of the CCP instance 1576A, as well as the virtualization layer 1554 and instances 1562A-R if implemented, are collectively referred to as software instance(s) 1552.

In some embodiments, the CCP instance 1576A includes a network controller instance 1578. The network controller instance 1578 includes a centralized reachability and forwarding information module instance 1579 (which is a middleware layer providing the context of the network controller 1478 to the operating system and communicating with the various NEs), and an CCP application layer 1580 (sometimes referred to as an application layer) over the middleware layer (providing the intelligence required for various network operations such as protocols, network situational awareness, and user-interfaces). At a more abstract level, this CCP application layer 1580 within the centralized control plane 1476 works with virtual network view(s) (logical view(s) of the network) and the middleware layer provides the conversion from the virtual networks to the physical view.

The centralized control plane 1476 transmits relevant messages to the data plane 1480 based on CCP application layer 1580 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 1480 may receive different messages, and thus different forwarding information. The data plane 1480 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPV4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 1480, the packet (or a subset of the packet header and content) is typically forwarded to the centralized control plane 1476. The centralized control plane 1476 will then program forwarding table entries into the data plane 1480 to accommodate packets belonging to the flow of the unknown packet. Once a specific forwarding table entry has been programmed into the data plane 1480 by the centralized control plane 1476, the next packet with matching credentials will match that forwarding table entry and take the set of actions associated with that matched entry.

While the embodiments have been described in terms of several embodiments, those skilled in the art will recognize that the embodiments are not limited to those described, can be practiced with modification and alteration within the spirit and scope of the appended claims. The description is thus to be regarded as illustrative instead of limiting.

1. A method of an accelerator selection process implemented by a computing node, the computing node having a plurality of accelerators, the method comprising:
receiving a request for an embedded insights-based accelerator selection for an application;
determining whether the application includes embedded insights as part of an executable package of the application; and
selecting at least one of the plurality of accelerators based on the embedded insights to execute the application.

2. The method of claim 1, further comprising:
determining whether an artificial intelligence model is available for generating profiling insights for the application; and
inferring the profiling insights based on the embedded insights including building insights and preferences insights.

3. The method of claim 1, wherein the selecting the at least one of the plurality of accelerators further comprising:
estimating insights compliance scores for each of the plurality of accelerators for the application; and
selecting the at least one of the plurality of accelerators based on a best insights compliance score.

4. The method of claim 3, wherein the insights compliance scores are generated from the embedded insights and a capacity specification for each of the plurality of accelerators.

5. The method of claim 4, wherein the insights compliance scores are further generated from profiling insights determined by an artificial intelligence model.

6. The method of claim 3, wherein estimating the insights compliance scores further comprising:
calculating a first compliance value by comparing a capacity of each of the plurality of accelerators to fulfill building insights in the embedded insights.

7. The method of claim 6, wherein estimating the insights compliance score further comprising:
calculating a second compliance value by comparing a capacity of each of the plurality of accelerators to fulfill preference insights in the embedded insights.

8. The method of claim 7, wherein estimating the insights compliance score further comprising:
calculating a third compliance value by comparing a capacity of each of the plurality of accelerators to fulfill profiling insights derived from the embedded insights or an artificial intelligence model.

9. The method of claim 8, wherein estimating the insights compliance score further comprising:
weighting the first compliance value, the second compliance value, and the third compliance value based on weighting specified by the embedded insights or an accelerator selection algorithm.

10. The method of claim 1, further including training an artificial intelligence model, wherein the training comprises:
selecting embedded insights for training the artificial intelligence model;
collecting profiling insights for different execution environments and accelerators for the application; and
training the artificial intelligence model using the selected embedded insights and collected profiling insights.

11. The method of claim 1, wherein the application includes serial logic to be executed by at least one general-purpose processor, and data-parallel logic to be executed by the at least one of the plurality of accelerators.

12. The method of claim 1, wherein the embedded insights include any one or more of building insights, profiling insights, and preferences insights.

13. The method of claim 12, wherein the building insights define characteristics of the application collected in a software build process include kernel complexity, kernel identity, or kernel footprint.

14. The method of claim 12, wherein the profiling insights define performance of at least one kernel of the application on at least one execution environment of one of the plurality of accelerators.

15. The method of claim 12, wherein preferences insights define information provided by a developer including any one or more of key performance objective and accelerator affinity.

16. (canceled)

17. A computing node comprising:
a machine readable storage medium having stored therein an application with embedded insights and an accelerator selection process; and
a set of processors including general purpose processors and accelerators to execute the application, wherein the accelerator selection process to:
receive a request for an embedded insights-based accelerator selection for an application;
determine whether the application includes embedded insights as part of an executable package of the application; and
select at least one of the accelerators based on the embedded insights to execute the application.

18. A machine-readable storage medium storing computer program code which when executed by a computer carries out functions of an application in an executable package, comprising:
an executable file including computer program code representing serial logic to be executed by a general purpose processor and data-parallel logic to be executed by an accelerator; and
a set of embedded insights wherein the embedded insights include any one or more of building insights, profiling insights, and preferences insights.

19. The machine-readable storage medium of claim 18, wherein the building insights define characteristics of the application collected in a software build process including kernel complexity, kernel identity, or kernel footprint.

20. The machine-readable storage medium of claim 18, wherein the profiling insights define performance of at least one kernel of the application on at least one execution environment of the accelerator.

21. The machine-readable storage medium of claim 18, wherein preferences insights define information defined by a developer including any one or more of key performance objective and accelerator affinity.
